(19) United States
(12) Patent Application Publication
(10) Pub. No.: US 2026/0186286 A1
(43) Pub. Date: Jul. 2, 2026

(54) IMAGING SYSTEM WITH A CHANGING DEVICE AND MICROSCOPE

(71) Applicant: Leica Microsystems CMS GmbH, Wetzlar (DE)

(72) Inventors: Jochen SIEPER, Wetzlar (DE); Moritz LEMP, Wetzlar (DE)

(21) Appl. No.: 19/291,657

(22) Filed: Aug. 6, 2025

(30) Foreign Application Priority Data
Aug. 8, 2024 (DE) 102024122618.8

(51) Int. Cl. G02B 21/24

(52) U.S. Cl. CPC G02B 21/24

(57) ABSTRACT

An imaging system includes a changing device. The changing device includes a changing holder configured to receive an optical element, an access element having an open state and a closed state, and a bistable element having a first stable state and a second stable state. The bistable element is configured to transition from the first stable state to the second stable state upon opening of the access element and to remain in the second stable state upon closing of the access element. The imaging system includes a controller configured to determine whether the bistable element is in the first stable state or the second stable state, and to determine that the access element has been opened and thereby access to the optical element has been enabled upon determining that the bistable element is in the second stable state.

### CROSS REFERENCE TO RELATED APPLICATIONS

This application claims benefit to German Patent Application No. DE 102024122618.8, filed on Aug. 8, 2024, which is hereby incorporated by reference herein.

### FIELD

Embodiments of the invention relate to an imaging system with a changing device. Embodiments of the invention further relate to a microscope.

### BACKGROUND

Many microscopes include interchangeable optical elements, such as objectives and eyepieces, but filters or beam splitters can also be interchangeable. Often, calibration of the microscope is required after changing the optical element, especially if the interchangeable optical elements are part of the microscope's optical beam path. However, calibrating a microscope can be a very time-consuming process, significantly reducing the time the microscope can be used for experiments. It is therefore desirable to avoid unnecessary calibration processes wherever possible.

### SUMMARY

Embodiments of the present invention provide an imaging system. The imaging system includes a changing device. The changing device includes a changing holder configured to receive at least one optical element and thereby to arrange the at least one optical element in an optical beam path of the imaging system. The changing device further includes an access element having an open state and a closed state. The access element is configured to allow access to the at least one optical element accommodated in the changing holder in the open state. The changing device further includes a bistable element having a first stable state and a second stable state. The bistable element is configured to transition from the first stable state to the second stable state upon opening of the access element and to remain in the second stable state upon closing of the access element. The imaging system includes a controller configured to determine whether the bistable element is in the first stable state or the second stable state, and to determine that the access element has been opened and thereby access to the at least one optical element accommodated in the changing holder has been enabled when the bistable element is in the second stable state.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

Embodiments of the invention will now be described in more detail below with reference to the figures. In the figures:

FIG. 1 shows an imaging system with a changing device according to an exemplary embodiment;

FIGS. 2a to 2d each show a schematic representation of a changing device of the imaging system according to a further exemplary embodiment;

FIGS. 3a to 3d each show a schematic representation of a changing device of the imaging system according to a further exemplary embodiment;

FIGS. 4a to 4d each show a schematic representation of a changing device of the imaging system according to a further exemplary embodiment;

FIG. 5 shows a microscope according to an exemplary embodiment; and

FIG. 6 shows the flowchart of a method for operating the imaging system according to some embodiments.

### DETAILED DESCRIPTION

Embodiments of the invention provide an imaging system with a changing device and a microscope which make it possible to reduce the number of calibration processes.

The imaging system comprises a changing device. The changing device comprises a changing holder which is designed to receive at least one optical element and thereby to arrange it in an optical beam path of the imaging system, and an access element which has an open and a closed state and is designed to enable access to the optical element received in the changing holder in the open state. The changing device further comprises a bistable element which has a first stable state and a second stable state and is designed to transition from the first stable state to the second stable state when the access element is opened and to remain in the second stable state when the access element is closed. The imaging system further comprises a control unit configured to determine whether the bistable element is in the first stable state or the second stable state, and to determine that the access element has been opened and thus access to the optical element accommodated in the changing holder has been enabled when the bistable element is in the second stable state.

With the help of the changing holder, the optical element can be arranged in the optical beam path of the imaging system. For example, a filter or a filter cube can be arranged in a beam path in front of a detector of the imaging system in order to detect only a specific wavelength range with the help of the detector.

The access element is, for example, a part of a housing of the imaging system, which comprises at least the changing holder. In the closed state, the access element prevents access to the changing holder and the optical element arranged therein, so that the optical element cannot be removed from the changing holder, for example during operation of the imaging system. In particular, the access element in the closed state prevents the optical element from being adjusted, thus making calibration of the imaging system necessary. In the open state, however, the access element allows access to the optical element, for example to exchange the optical element for another one. If the access element has been opened, i.e., has been in the open state at least once, there is a possibility that the optical element has been removed, replaced or adjusted. However, this means that if the access element was opened after the imaging system had been calibrated, recalibration may be necessary.

When the imaging system is in operation, it could, for example, be determined by reading a sensor in the area of the access element when the access element is opened. However, this is sometimes not possible when the imaging system is switched off.

The switching device of the proposed imaging system therefore comprises the bistable element. When the access element is opened, the bistable element changes from the first stable state to the second stable state and remains there. This detection of a successful opening of the access element works when the imaging system is switched off and thus represents a power-free “state memory.”

The bistable element, which is in the second stable state after opening, must then be returned to the first stable state. This can be done manually by a user, for example.

If the access element was opened when the imaging system was switched off, this can be determined by the control unit based on the state of the bistable element. The changing device can thus ensure that it is reliably determined whether the access element has been opened and thus whether access to the optical element arranged in the changing holder was possible. Since recalibration is often only required if there is a possibility that the optical element has been removed, replaced or adjusted, the number of calibration processes can be reduced and the operating time of the imaging system can be increased.

In one embodiment, the control unit is configured to determine, upon switching on the imaging system, whether the bistable element is in the first stable state or the second stable state. The control unit may further be configured to determine that, in a switched-off state of the imaging system, the access element has been opened and thus access to the optical element accommodated in the changing holder has been enabled when the bistable element is in the second stable state. When the access element was opened in the off state of the imaging system, the bistable element was moved from the first stable state to the second stable state. If the bistable element is in the second stable state when switched on, the access element was opened when the imaging system was switched off and access to the optical element was possible. Based on this information, the control unit can, for example, initiate a recalibration or inform the user that a recalibration of the imaging system is required before, for example, starting an experiment. This ensures that the measurement results obtained in the experiment are precise by minimizing the risk of errors that could be caused by incorrect calibration.

In a further embodiment, the changing device comprises a first sensor which is designed to determine whether the bistable element is in the first stable state or in the second stable state. The control unit may be configured to determine whether the bistable element is in the first stable state or in the second stable state using first sensor data provided by the first sensor. This allows the control unit to reliably determine whether the access element has been opened using the first sensor.

In a further embodiment, the changing device comprises a second sensor which is designed to determine whether the access element is in the open state or in the closed state. The control unit may be configured to determine whether the access element is in the open state or in the closed state using second sensor data provided by the second sensor. Using the second sensor, the control unit can reliably determine whether access to the optical element is currently possible. For example, if the user opens the access element while the imaging system is in operation, i.e., when the imaging system is switched on, the control unit can detect this using the second sensor and, for example, cause a warning to be issued. This prevents, for example, the user from accidentally adjusting the optical element located in the changing holder, which would require recalibration.

The first sensor and/or the second sensor can, for example, each be one of the following sensor types: a push button, a light barrier, a Hall sensor, an inductive proximity switch and a capacitive proximity switch.

In a further embodiment, the imaging system comprises an output unit. The control unit may be configured to control the output unit to output a corresponding warning when the control unit has determined that the access element has been opened. The output unit may, for example, comprise a screen, a display, a warning lamp or other optical output elements. The output unit can also include acoustic output elements, such as a loudspeaker or a buzzer. The control unit can use the output unit to inform the user that the access element has been opened and that access to the optical element held in the changing holder was therefore possible. The control unit can also inform the user that recalibration is required, which can be initiated manually by the user, for example. Furthermore, the control unit can be designed to control the output unit to output a corresponding warning when the control unit has determined that the access element is currently in the open state.

In a further embodiment, the control unit is configured to start a calibration process of the imaging system when the control unit has determined that the access element has been opened. If the access element has been opened, recalibration is required. In this embodiment, the imaging system becomes proactive and starts the calibration process required for recalibration. The calibration process can be started automatically by the control unit. The control unit can also be designed to start the calibration process of the imaging system only after the user has confirmed. The user's confirmation can, for example, be a user input into an input unit of the imaging system. This informs the user that recalibration is required, but gives the user the choice of whether to perform the calibration process now or at a later time.

In a further embodiment, the access element comprises a pull-out drawer or a swivel drawer. The pull-out drawer or the swivel drawer can, for example, be designed as part of the housing of the imaging system and enable easy and quick access to the changing device and the optical element arranged therein.

In a further embodiment, the pull-out drawer or the swivel drawer comprises the changing holder. If the pull-out drawer or the swivel drawer is designed, for example, as part of the housing of the imaging system, in this embodiment the changing holder can be led out at least partially from the housing in order to enable easy and quick access to the optical element arranged therein.

In a further embodiment, the access element comprises a flap of the housing of the imaging device. In this embodiment, the changing holder is, for example, fixedly arranged within the housing. Opening the flap does not move the changing holder, which minimizes the risk of the optical element located in the changing holder being displaced and requiring readjustment. The flap also allows the housing to be closed so that no stray light can enter the optical beam path in which the optical element is arranged.

In a further embodiment, the bistable element comprises a mechanical follower which is designed to be moved from a first position to a second position by mechanical contact with the access element when the access element is opened and to remain in the second position when the access element is closed, so that the first stable state corresponds to the first position of the follower and the second stable state corresponds to the second position of the follower. In such an embodiment, the access element comprises or forms a follower, so that when the access element moves, the follower of the bistable element is moved. The position of the follower can, for example, be detected by the first sensor. The follower can, for example, be linearly mounted or comprise a rotatable disk. After the control unit has determined that the follower is in the second position, the follower can be returned to the first position, for example by motor or manually by a user. The follower is brought into the second position purely by mechanical contact with the access element. This means that it is not necessary, for example, to supply the bistable element with electrical energy in order to determine whether the access element has been opened. Unlike, for example, a button or other sensor, the bistable element can also be used to determine whether the access element was opened when the imaging system was switched off.

In a further embodiment, the bistable element comprises a bistable lifting magnet. The first stable state may correspond to a first position of an armature of the lifting magnet. The second stable state may correspond to a second position of the armature of the lifting magnet. In this embodiment, the armature of the lifting magnet forms the mechanical follower. The position of the armature can also be detected, for example, by the first sensor. The control unit can be designed to control the lifting magnet in such a way that the armature is returned to the first position. The armature can also be returned to the first position using a motor or manually by a user. In this embodiment, too, it is not necessary for the imaging system to be in a switched-on state in order to be able to detect whether the access element has been opened.

In a further embodiment, the control unit is designed to control the bistable element in order to return the bistable element to the first stable state.

For example, the control unit may be configured to control the bistable element after completion of the calibration process in order to return the bistable element to the first stable state. To return the bistable element to the first stable state, the control unit can, for example, control a motor that returns the mechanical follower of the bistable element to the first position. The control unit can also be designed to control the lifting magnet in such a way that the armature is returned to the first position. By automatically returning the bistable element to the first state, there is no need to manually reset the bistable element in order to detect a renewed opening of the access element. This makes the imaging system very user-friendly.

In a further embodiment, the changing holder is designed to accommodate at least one of the following optical elements: a filter, a filter cube, a fluorescence filter, a beam splitter, a lens, a lens element and an aperture stop. The above-mentioned optical elements are widely used in various types of imaging systems. The imaging system is therefore versatile.

Embodiments of the invention further relate to a microscope comprising the imaging system described above with the changing device. The microscope has the same advantages as the imaging system. In particular, the microscope be further trained with features described in this document in conjunction with the imaging system. Furthermore, the above-described imaging system can be further developed using the features described in this document in conjunction with the microscope.

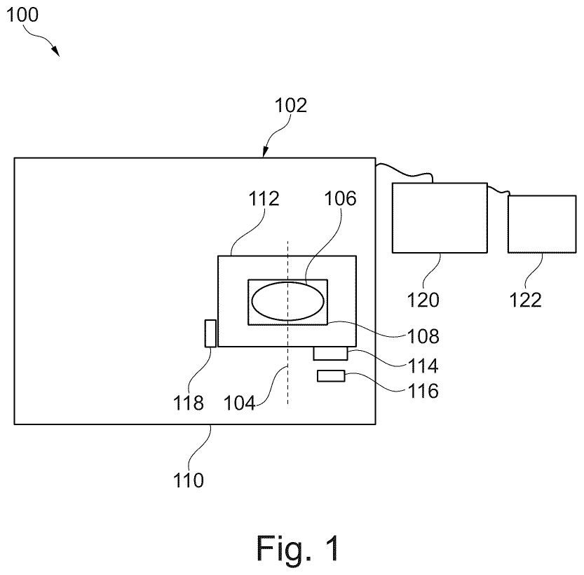

FIG. 1 shows a schematic representation a imaging system 100 with a changing device 102 according to an exemplary embodiment. The imaging system 100 is, for example, part of a microscope, a slide scanner (also called a slide scanner), a spectrometer or another optical device and comprises at least one optical beam path 104.

The imaging system 100 has a changing device 102 which is designed such that at least one interchangeable optical element 106 can be introduced into the optical beam path 104. The interchangeable optical element 106 may be, for example, a filter, a filter cube, a beam splitter, a lens, a lens element, an aperture stop, or a similar optical element. In FIG. 1, the optical element 106 is shown purely as an example as a lens. The changing device 102 comprises a changing holder 108 in which the optical element 106 can be arranged. When the optical element 106 is received in the changing holder 108, the optical element 106 can be inserted into the optical beam path 104 of the imaging system 100, as shown in FIG. 1.

In the embodiment shown, the optical beam path 104 is arranged within a housing 110 of the imaging system 100. In order to enable access to the changing holder 108 and thus to the optical element 106, the changing device 102 comprises an access element. The access element has an open state in which access to the changing holder 108 and the optical element 106 arranged therein is possible. When the access element is opened, for example, the optical element 106 can be removed from the changing holder 108 or exchanged for another optical element 106. The access element 112 also has a closed state in which no access to the changing holder 108 and the optical element 106 arranged therein is possible. For example, the access element 112 may be closed to ensure safe operation of the imaging system 100.

The changeover device 102 also includes a bistable element 114 having a first stable state and a second stable state. If the bistable element 114 is in the first stable state, it can only transition to the second stable state by an external force. Conversely, the bistable element 114 can only be returned to the first stable state by an external force. In the changing device 102, the bistable element 114 is arranged and designed to be brought from the first stable state to the second stable state by opening the access element 112, for example by mechanical contact with the access element 112. The bistable element 114 is further configured to remain in the second stable state when the access element 112 is closed.

The changing device 102 further comprises a first sensor 116, which is arranged on the bistable element in FIG. 1, and a second sensor 118, which is arranged to the left of the access element 112 in FIG. 1. The first sensor 116 is designed to determine the state of the bistable element 114, i.e., whether the bistable element 114 is in the first stable state or in the second stable state. The result of this determination can be provided by the first sensor 116, for example, in the form of first sensor data. The second sensor 118 is designed to determine the state of the access element 112, i.e., whether the access element 112 is currently open or closed. The result of this determination can be provided by the second sensor 118, for example in the form of second sensor data.

A control unit 120 of the imaging system 100 is designed to determine whether the access element 112 was opened and thus access to the optical element 106 arranged in the changing holder 108 was possible. For this purpose, the control unit 120 first determines whether the bistable element 114 is in the first stable state or in the second stable state. For this purpose, the control unit 120 processes, for example, the first sensor data. If the control unit 120 has determined that the bistable element 114 is in the second stable state, then the control unit 120 determines that the access element 112 has been opened. This determination may be made at various times during operation of the imaging system 100. In one exemplary embodiment, when the imaging system 100 is turned on, the control unit 120 determines the state of the bistable element 114. If the control unit 120 determines that the bistable element 114 is in the second stable state when switched on, then the control unit 120 determines that the access element 112 has been opened in the switched-off state. This means that access to the optical element 106 was possible while the imaging system 100 was switched off.

Once the control unit 120 has determined that the access element 112 has been opened, the control unit 120 may take a number of actions. Since in this case access to the optical element 106 arranged in the changing holder 108 was possible, there is a possibility that the optical element 106 was adjusted or removed and thus a previously performed calibration of the imaging system 100 must be carried out again. In one exemplary embodiment, the control unit 120 automatically starts the recalibration when the control unit 120 has determined that access to the optical element 106 arranged in the changing holder 108 was possible. In another embodiment, the control unit 120 starts the recalibration only after confirmation by a user. After calibration, the control unit 120 can control the bistable element 114 to return the bistable element 114 to the first state.

The exemplary embodiment of the imaging system 100 shown in FIG. 1 further comprises an output unit 122, for example a display. The output unit 122 can be controlled to output information or warnings to the user, for example. In one exemplary embodiment, the control unit 120 is configured to control the output unit 122 to output a warning. For example, the control unit 120 may warn the user that the access element 112 has been opened in the off state or that the access element 112 is currently open. The control unit 120 may further inform the user that the bistable element 114 needs to be returned to the first state.

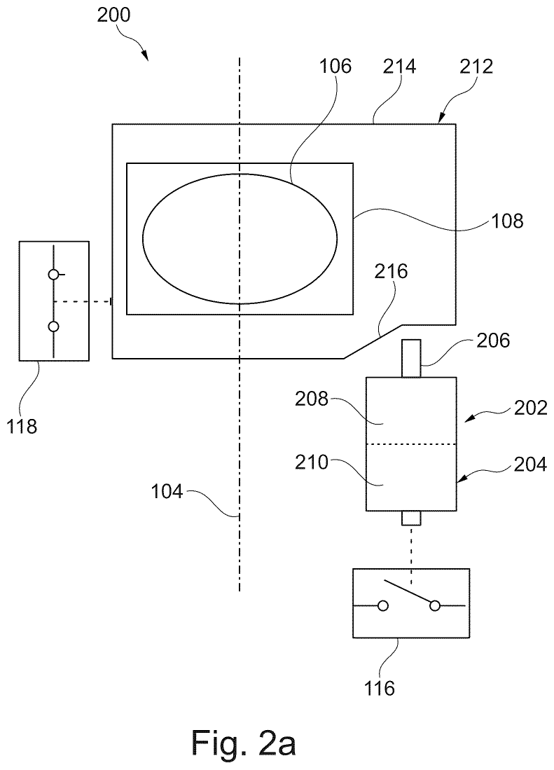

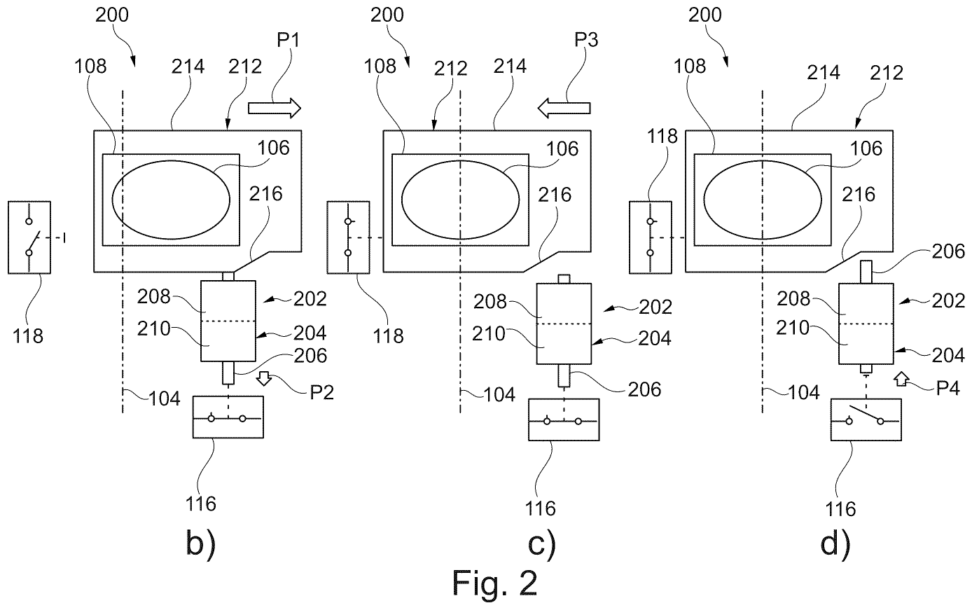

FIGS. 2a to 2d each show a schematic representation of the changing device 200 of the imaging system 100 according to another exemplary embodiment. In the exemplary embodiment shown in FIGS. 2a to 2d, the bistable element 202 comprises a lifting magnet 204.

The lifting magnet 204 comprises an armature 206 which is linearly mounted and surrounded by two coils 208, 210. By applying a voltage to a first coil 208, the armature 206 can be moved to a first position. If the voltage is no longer applied, the armature 206 remains in the first position. By applying a voltage to a second coil 210, the armature 206 can be moved to a second position. If no voltage is applied to the second coil 210, the armature 206 remains in the second position. The first position of the armature 206 thus corresponds to the first stable state and the second position of the armature 206 corresponds to the second stable state. The position of the armature 206 is detected by the first sensor 116. In FIG. 2a, the armature 206 is in the first position, i.e., the bistable element 202 is in the first state. This represents the starting position.

In the exemplary embodiment shown in FIGS. 2a to 2d, the access element 212 comprises a pull-out drawer 214 which comprises the changing holder 108. The pull-out drawer 214 further comprises a driver 216 which is designed as a ramp. When the pull-out drawer 214 is opened, the driver 216 hits the armature 206 and moves the armature 206 into the second position by mechanical contact. The armature 206 thus forms a mechanical follower. The situation when opening the pull-out drawer 214 is shown in FIG. 2b, in which a first arrow P1 indicates the direction of movement of the pull-out drawer 214 when opening. A second arrow P2 in FIG. 2b indicates the direction of movement of the armature 206 when opening the pull-out drawer 214. The fact that the pull-out drawer 214 is open is registered by the second sensor 118.

The driver 216 of the pull-out drawer 214 is further designed such that the armature 206 remains in the second position when the pull-out drawer 214 is closed. The situation when closing the pull-out drawer 214 is shown in FIG. 2c, in which an arrow P3 indicates the direction of movement of the pull-out drawer 214 when closing. If the armature 206 is in the second position, it can thus be assumed that the pull-out drawer 214 has been opened and access to the optical element 106 arranged in the changing holder 108 was possible. To return the armature 206 to the first position, the lifting magnet 204 can be controlled to supply current to the first coil 208. The return of the armature 206 is shown in FIG. 2d, in which an arrow P4 indicates the direction of movement of the armature 206 when returning to the first position.

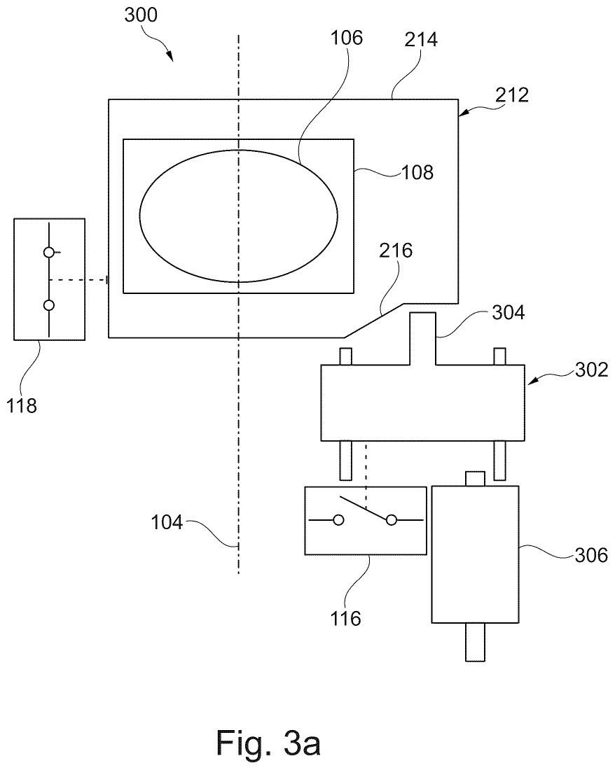

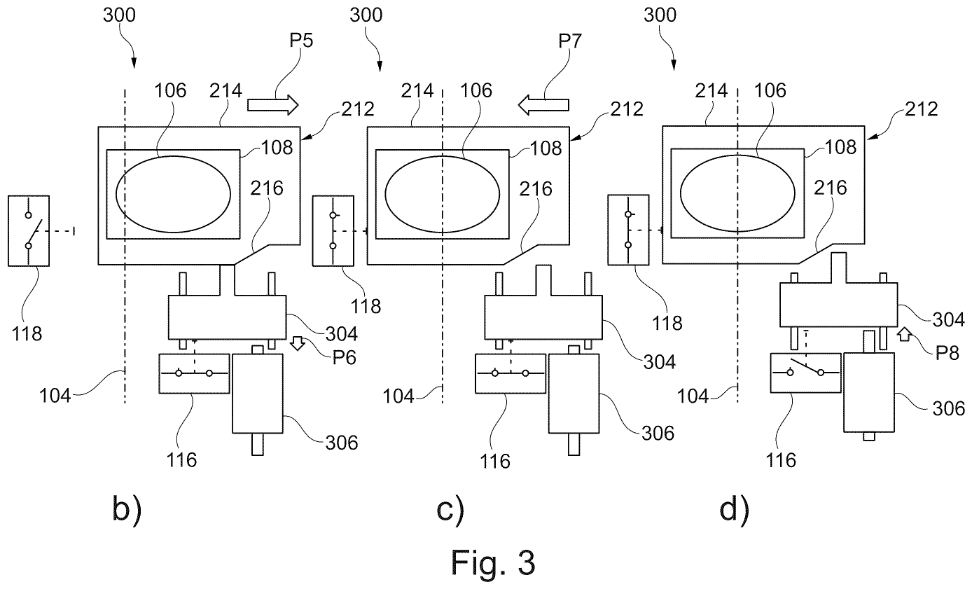

FIGS. 3a to 3d each show a schematic representation of the changing device 300 of the imaging system 100 according to another exemplary embodiment. In the exemplary embodiment shown in FIGS. 3a to 3d, the bistable element 302 comprises a linearly mounted follower 304.

The linearly mounted follower 304 corresponds in its function to the armature 206 of the lifting magnet 204. In FIG. 3a, the linearly mounted follower 304 is in a first position corresponding to the first stable state of the bistable element 302. FIG. 3a shows the starting position. When the pull-out drawer 214 is opened, the driver 216 of the pull-out drawer 214 comes into contact with the linearly mounted follower 304 and moves it into a second position. The situation when opening the pull-out drawer 214 is shown in FIG. 3b, in which a first arrow P5 indicates the direction of movement of the pull-out drawer 214 when opening. A second arrow P6 in FIG. 3b indicates the direction of movement of the linearly mounted follower 304 when opening the pull-out drawer 214. When the pull-out drawer 214 is closed, the linearly mounted follower 304 remains in the second position, which thus corresponds to the second stable state. The situation when closing the pull-out drawer 214 is shown in FIG. 3c, in which an arrow P7 indicates the direction of movement of the pull-out drawer 214 when closing.

The changing device 300 further comprises a linear motor 306 which is designed to return the linearly mounted follower 304 to the first position. The return of the linearly mounted follower 304 is shown in FIG. 3d, in which an arrow P8 indicates the direction of movement of the linearly mounted follower 304 when returning to the first position.

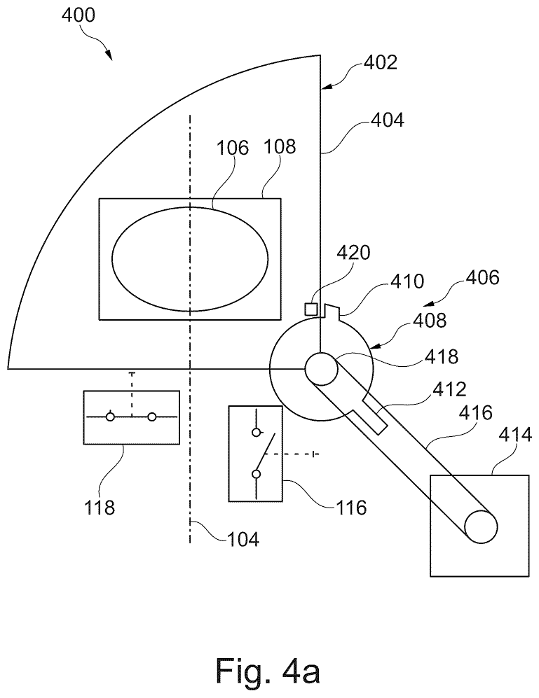

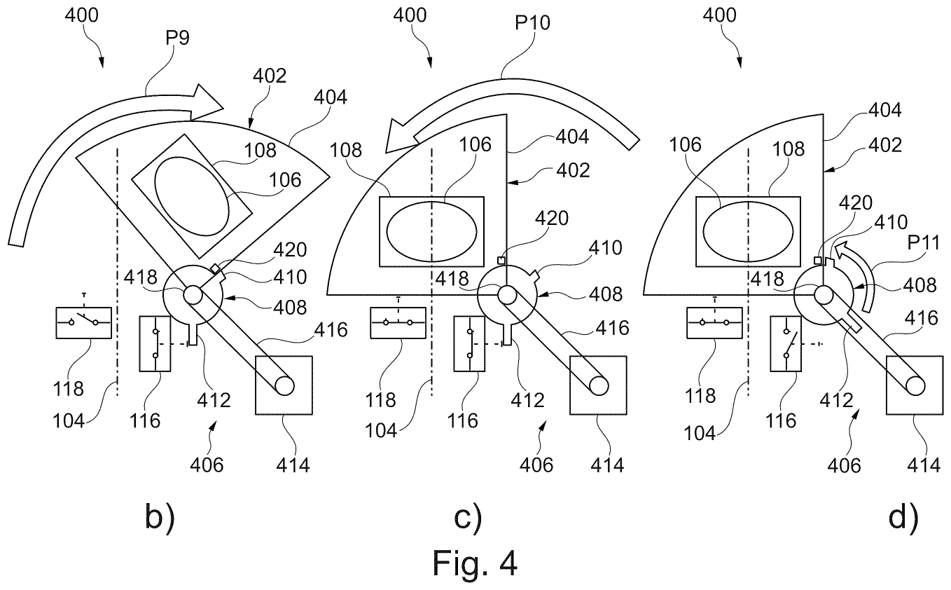

FIGS. 4a to 4d each show a schematic representation of the changing device 400 of the imaging system 100 according to another exemplary embodiment. In the exemplary embodiment shown in FIGS. 4a to 4d, the access element 402 comprises a swivel drawer 404 which comprises the changing holder 108.

In the exemplary embodiment shown in FIGS. 4a to 4d, the bistable element 406 comprises a disk 408 on which two cams 410, 412 are formed. The changing device 400 further comprises a rotary motor 414 which is connected, purely by way of example, to an axis 418 of the disk 408 via a belt 416. A first cam 410 of the disk 408 is in a first position in FIG. 4a, which corresponds to the first stable state. A driver 420 of the swivel drawer 404 strikes the first cam 410 of the disk 408 when the swivel drawer 404 is opened. The first cam 410 thus corresponds in its function to the armature 206 of the lifting magnet 204 and the linearly mounted follower 304. The force exerted by the driver 420 on the pulley 408 is greater than the friction between the belt 416 and the axis 418 of the pulley 408. The first cam 410 is thus rotated out of the first position. The opening of the swivel drawer 404 is shown in FIG. 2b, in which an arrow P9 indicates the direction of rotation of the swivel drawer 404 and the disk 408 during opening. When the swivel drawer 404 is opened, the first cam 410 is in a second position. When the first cam 410 is in the second position, the disk 408 is rotated such that a second cam 412 abuts the first sensor 116. As a result, the second sensor 118 detects that the first cam 410 is in the second position. When the swivel drawer 404 is closed, the disk 408 remains in its position, i.e., the first cam 410 remains in the second position, which thus corresponds to the second stable state. The situation when closing the pull-out drawer 214 is shown in FIG. 4c, in which an arrow P10 indicates the direction of movement of the swivel drawer 404 when closing. With the help of the rotary motor 414, the disk 408 can then be rotated back to return the first cam 410 to the first position. The reversing of the disk 408 is shown in FIG. 4d, in which an arrow P11 indicates the direction of movement of the disk 408 during reversing.

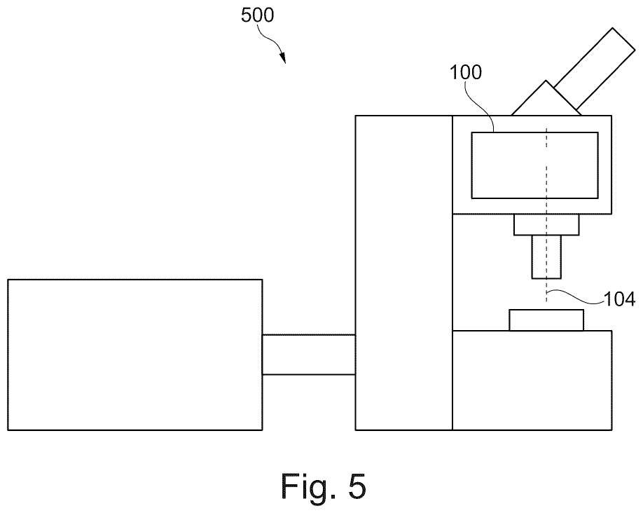

FIG. 5 shows a microscope 500 according to an exemplary embodiment. The microscope 500 comprises the imaging system 100, which is shown purely schematically as a box. The optical beam path 104 is a beam path of the microscope 500.

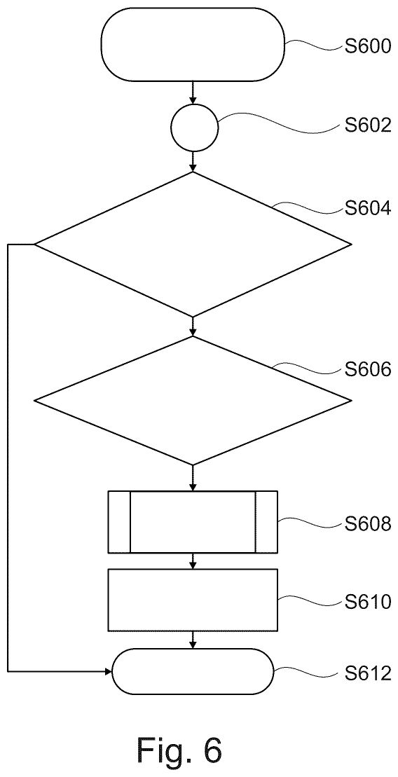

FIG. 6 shows the flowchart of an exemplary method for operating the imaging system 100.

The method is started in step S600. In step S602, the imaging system 100 is switched on, for example by the user. In step S604, it is determined whether the access element 112, 212, 402 was opened while the imaging system 100 was turned off. In one embodiment, the control unit 120 determines the state of the bistable element 114, 202, 302, 406 based on the first sensor data. If the bistable element 114, 202, 302, 406 is in the second state, the control unit 120 determines that the access element 112, 212, 402 has been opened and the method continues in step S606. If the bistable element 114, 202, 302, 406 is in the first state, the control unit 120 determines that the access element 112, 212, 402 has not been opened and the method is terminated in step S612. In step S606, it is determined whether the access element 112, 212, 402 is currently open. In one embodiment, the control unit 120 determines whether the access element 112, 212, 402 is currently open based on the second sensor data. If the access element 112, 212, 402 is currently open, a corresponding warning can be issued to the user. In one embodiment, the control unit 120 controls the output unit 122 to output the warning. The warning may also be accompanied by a request to the user to close the access element 112, 212, 402. The method then continues in step S608 when the access element 112, 212, 402 has been closed.

In step S608, a calibration of the imaging system 100 is performed. This ensures that the imaging system 100 is correctly adjusted, even if the optical element 106 has been moved, adjusted or changed since the last calibration. In one embodiment, the controller 120 initiates a calibration process to start the calibration of the imaging system 100. In step S610, after calibration, the bistable element 114, 202, 302, 406 is returned to the first stable state. This can be done manually by the user who has been prompted to do so by a corresponding output. However, this can also be done automatically, for example by the control unit 120 controlling the bistable element 114, 202, 302, 406 accordingly. The method is then terminated in step S612 when the bistable element 114, 202, 302, 406 is again in the first stable state.

The term “and/or” can be abbreviated as “/” and includes all combinations of one or more of the associated listed items.

Although some aspects have been described within the framework of a device, it is clear that such aspects also constitute a description of the corresponding method, a block or a device corresponding to a method step, or a function of a method step. Similarly, aspects described within the framework of a method step also constitute a description of a corresponding block or element, or a feature of a corresponding device.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

100 Imaging system
102 Changing device
104 Beam path
106 Optical element
108 Changing holder
110 Housing
112 Access element
114 Bistable element
116, 118 Sensor
120 Control unit
122 Output unit
200 Changing device
202 Bistable element
204 Lifting magnet
206 Armature
208, 210 Coil
212 Access element
214 Pull-out drawer
216 Driver
300 Changing device
302 Bistable element
304 Follower
306 Linear motor
400 Changing device
402 Access element
404 Swivel drawer
406 Bistable element
408 Disk
410, 412 Cam
414 Rotary motor
416 Belt
418 Axis
420 Driver
P1-P11 Arrow

1. An imaging system comprising a changing device, wherein the changing device comprises:
a changing holder configured to receive at least one optical element and thereby to arrange the at least one optical element in an optical beam path of the imaging system,
an access element having an open state and a closed state, the access element being configured to allow access to the at least one optical element accommodated in the changing holder in the open state, and
a bistable element having a first stable state and a second stable state, the bistable element being configured to transition from the first stable state to the second stable state upon opening of the access element and to remain in the second stable state upon closing of the access element;
wherein the imaging system comprises a controller configured to determine whether the bistable element is in the first stable state or the second stable state, and to determine that the access element has been opened and thereby access to the at least one optical element accommodated in the changing holder has been enabled when the bistable element is in the second stable state.

2. The imaging system according to claim 1, wherein the controller is configured to determine, as the imaging system is switched on, whether the bistable element is in the first stable state or the second stable state, and to determine that, in a switched-off state of the imaging system, the access element has been opened and thereby the access to the at least one optical element accommodated in the changing holder has been enabled when the bistable element is in the second stable state.

3. The imaging system according to claim 1, wherein the changing device comprises a first sensor configured to determine whether the bistable element is in the first stable state or in the second stable state.

4. The imaging system according to claim 1, wherein the changing device comprises a second sensor configured to determine whether the access element is in the open state or in the closed state.

5. The imaging system according to claim 1, comprising an output unit, wherein the controller is configured to control the output unit to output a corresponding warning based on a determining by the control unit that the access element has been opened.

6. The imaging system according to claim 1, wherein the controller is configured to start a calibration process of the imaging system based on a determining by the control unit that the access element has been opened.

7. The imaging system according to claim 1, wherein the access element comprises a pull-out drawer or a swivel drawer.

8. The imaging system according to claim 7, wherein the pull-out drawer or the swivel drawer comprises the changing holder.

9. The imaging system according to claim 1, wherein the access element comprises a flap of a housing of the imaging device.

10. The imaging system according to claim 1, wherein the bistable element comprises a mechanical follower configured to be moved from a first position to a second position by mechanical contact with the access element upon opening of the access element and to remain in the second position upon closing of the access element, such that the first stable state corresponds to the first position of the mechanical follower and the second stable state corresponds to the second position of the mechanical follower.

11. The imaging system according to claim 1, wherein the bistable element comprises a lifting magnet, the first stable state corresponds to a first position of an armature of the lifting magnet, and the second stable state corresponds to a second position of the armature of the lifting magnet.

12. The imaging system according to claim 1, wherein the controller is configured to control the bistable element to return the bistable element to the first stable state.

13. The imaging system according to claim 1, wherein the changing holder is configured to receive at least one of the following optical elements: a filter, a filter cube, a fluorescence filter, a beam splitter, a lens, a lens element, and/or an aperture stop.

14. A microscope, having the imaging system according to claim 1.
